(19) United States
(12) Patent Application Publication
(10) Pub. No.: US 2016/0195110 A1
(43) Pub. Date: Jul. 7, 2016

(54) ROTOR FOR A THERMAL TURBOMACHINE

(71) Applicant: SIEMENS AKTIENGESELLSCHAFT, München (DE)

(72) Inventors: Karsten Kolk, Mulheim a.d. Ruhr (DE); Peter Schröder, Essen (DE); Dirk Springborn, Berlin (DE); Vyacheslav VEITSMAN, Gelsenkirchen (DE)

(73) Assignee: Siemens Aktiengesellschaft, Munich (DE)

(21) Appl. No.: 14/904,521

(22) PCT Filed: Jun. 16, 2014
(86) PCT No.: PCT/EP2014/062518

§ 371 Date: Jan. 12, 2016

(30) Foreign Application Priority Data
Jul. 17, 2013 (EP) 13176862.4

(51) Int. Cl. F04D 29/66; F04D 29/32; F04D 29/58; F01D 5/08

(52) U.S. Cl. CPC F04D 29/667; F01D 5/085; F04D 29/321; F04D 29/5846; F05D 2220/32; F05D 2240/61

(57) ABSTRACT

A rotor for a thermal turbomachine, in particular a gas turbine, designed to conduct a medium, such as compressor air, in the interior of the rotor. In order to conduct the medium in the interior with low flow losses and at the same time to specify a rotor that can be produced comparatively simply and economically, a separately produced blade wheel is arranged between the mutually adjacent hub regions of the two rotor disks, and a sleeve is provided for fastening the blade wheel to one of the two rotor disks, which sleeve extends through the central opening of the one rotor disk and includes a collar serving as a stop at a first end of the sleeve and includes a second end opposite the first end, on which second end the blade wheel is fastened.

### CROSS REFERENCE TO RELATED APPLICATIONS

This application is the US National Stage of International Application No. PCT/EP2014/062518 filed Jun. 16, 2014, and claims the benefit thereof. The International Application claims the benefit of European Application No. EP13176862 filed Jul. 17, 2013. All of the applications are incorporated by reference herein in their entirety.

### FIELD OF INVENTION

The invention relates to a rotor for a thermal turbomachine, which rotor is configured in the interior for conducting a medium.

### BACKGROUND OF INVENTION

Rotors for thermal turbomachines such as axial compressors and gas turbines are known in different designs from the comprehensively available prior art. For example, welded rotors are known for gas turbines, in the case of which welded rotors drums of different width are welded to one another to form a monolithic rotor. Secondly, it is known to stack a plurality of disk-shaped elements (also known as rotor disks) and to brace them with the aid of one or more tie rods to form a fixed structure. Even combinations of said designs are known. Rotor blades are mounted on the outside of all rotors, which rotor blades can be assigned in the case of gas turbines, for example, either to the compressor or to the turbine unit. Regardless of the design, a medium can be introduced into the interior of the rotors via holes which are arranged in the rotor shell, in order to conduct said medium from the feed position to a second axial position, where the medium is removed from the rotor again. This method is used, in particular, in gas turbines, in order to remove cooling air from the main flow path of the compressor of a gas turbine on the rotor side and to conduct it to the turbine unit, where, guided out of the rotor interior again, it can be used for cooling air purposes and/or sealing air purposes.

In order to make an aerodynamically efficient removal of air from the compressor of a gas turbine and efficient conducting of the air in the rotor interior possible, different constructions are known.

For example, DE 196 17 539 A1 has disclosed conducting the air which flows with a swirl into the rotor cavity on account of the rotation of the rotor via radially extending ribs to the rotor center. The conducting causes the circumferential speed of the air which exits from the holes to be reduced as the radius becomes smaller, which prevents an impermissibly great swirl formation. For this reason, the ribs are called “deswirlers” in English.

### SUMMARY OF INVENTION

It is an object of the present invention to provide an alternative solution, in which firstly the pressure and flow losses in the rotor interior are reduced further and which secondly is a solution which can be produced simply, is reliable and is therefore inexpensive.

This object of the invention is achieved by way of a rotor in accordance with the features of the independent claim. Advantageous refinements are specified in the dependent claims, the features of which can be combined with one another in accordance with the back-references.

The inventors have recognized that flow losses can occur in the region of the radial ribs in the prior art, since said ribs tend to lie comparatively wide apart from one another in the circumferential direction and there are therefore relatively great flow cross sections at this point for the medium which is removed from the turbomachine. This is all the more true, since the flow passages between the known ribs also have a comparatively great axial extent. In order to eliminate said disadvantage, it is proposed to also axially delimit the flow cross section of the flow passages between the ribs. The axial delimitation is advantageously to be configured at least over a large part of the radial extent of the ribs.

For this reason, a separately manufactured impeller wheel is arranged between the hub regions of mutually adjacent rotor disks, of which one of the two rotor disks has holes for introducing a medium into the rotor interior, the impeller wheel bearing with a first side against the hub region of the second rotor disk, and the second side of said impeller wheel, which lies opposite the first side, having a number of ribs which extend from the outside to the inside.

In contrast to the known solutions, it is therefore proposed by way of the invention that the ribs are not a monolithic part of one of the two rotor disks, but rather are part of an impeller wheel which comprises, as rib carrier, a plate-shaped ring, to which the ribs are fastened.

Therefore, the abovementioned refinement can be manufactured substantially more simply and less expensively than rotor disks, in which the ribs are an integral constituent part of the rotor disk. In addition, the impeller wheel can be manufactured from a different material than the rotor disk itself, since the boundary conditions, for example the maximum use temperatures, can be different. Therefore, the relatively complex geometry of the ribs of a rotor disk is separated from the latter, since it has been recognized by the inventors that the ribs can also be arranged on a separate component, the impeller wheel. The impeller wheel can be manufactured mechanically from a solid ring. As an alternative, the impeller wheel can also be joined from individual parts (a ring and a plurality of ribs) by way of welding. A casting method for manufacturing the impeller wheel may also be suitable in the case of a complex geometry of the rib.

In order to achieve particularly reliable fastening of the impeller wheel in the rotor, it is provided, furthermore, that a sleeve is provided for fastening the impeller wheel to one of the two rotor disks, which sleeve extends through the central opening of the relevant rotor disk and, at its first end, comprises a collar which serves as a stop and a second end which lies opposite the first end, on which second end the impeller wheel is fastened. This permits the manufacture of a module comprising one of the two rotor disks of the disk pair and the impeller wheel which can then be mounted jointly in the customary stacking process during the assembly of the rotor. As a result, simple assembly of the rotor can be ensured, the components of which are always situated in their intended position.

It is to be noted that the terms “axial” and “radial” and “outside” and “inside” always relate to the rotational axis of the rotor disk or the rotor. In addition, the rotor interior is to be understood as that cavity in the interior of the rotor which is delimited by the rotor disks. In other words, the holes of the first rotor disk are not part of the rotor interior.

According to a first advantageous development of the impeller wheel, the outer edge of the rib carrier lies on a greater radius than the outer ends of the ribs, with the result that, in the installed state when the impeller wheel is mounted between the hub regions of the relevant rotor disks, the medium which exits from the holes can be conducted inward in an improved manner on account of the rib carrier which is guided radially further to the outside. Eddies in the inflow regions of the flow passages can therefore be avoided, which reduces pressure losses during the conducting of the medium.

In a further advantageous refinement of the invention, each of the ribs has an edge which faces the first rotor disk and the radial contour of which corresponds to the radial contour of the first rotor disk in the hub region. As a result, the gap between the edges of the ribs and the hub contour of the first rotor disk can be kept comparatively small over the entire radial rib extent, which makes efficient conducting of the medium along the rib possible, without transverse flows occurring through a gap which is formed by the rib and the hub region.

According to a further advantageous refinement, the impeller wheel is screwed onto the sleeve. To this end, the impeller wheel has an internal thread in its central opening, which internal thread is screwed onto an external thread which is provided at the second end of the sleeve. For particularly reliable fastening of the impeller wheel in the rotor, first of all the thread-side end of the sleeve is pushed into the central opening of one of the two rotor disks, advantageously the second rotor disk, until the collar of the sleeve bears against the side face of the hub region. The impeller wheel is then screwed onto the thread-side end, as it were as a threaded nut. During tightening of the impeller wheel, the cylindrical section of the sleeve is expanded, as a result of which sufficiently secure fastening for the function can be ensured. The assembly which is braced in this way can then be threaded onto the tie rod as usual during stacking of the rotor. If necessary, the assembly can be secured against release by way of calking in the region of the central thread.

The development is particularly advantageous, in which the impeller wheel is of hollow channel-like configuration on the second side radially on the inside between the ribs in order to deflect a flow. This reduces the aerodynamic losses in the medium when it has to be deflected from a mainly radially directed flow into a mainly axially directed flow direction. It goes without saying that this also applies to a reversed flow direction. At the same time, in conjunction with the screwed connection, this solution makes a comparatively large axial screwing length possible with a reduced rib carrier thickness: as a result of the hollow channel-like design of the rib carrier at its central opening, the internal thread which is arranged in the central opening can be of longer configuration as a consequence than without a hollow channel, which ensures a further improved screwed connection while maintaining a low weight of the impeller wheel.

A plurality of advantages arise overall by way of the invention: first of all, the simplification of the manufacture, that is to say the reduction of potential manufacturing faults, can be specified by way of a reduction of the component complexity. In addition, the complex geometries are no longer arranged on the comparatively more expensive components, the rotor disks, but rather are realized on a separately manufactured component, the impeller wheel. In addition, the separation of the complex geometries leads to a cost reduction of that rotor disk, by way of which the removal of the medium from the main flow path is realized. The other, second rotor disk can be of classic configuration, since the impeller wheel assumes the function of the improved flow conducting in the interior of the rotor. As a result of the structural separation, different materials can be used and combined.

Therefore, the invention relates overall to a rotor for a thermal turbomachine, in particular a gas turbine, which rotor is configured to conduct a medium, for example compressor air, in its interior. In order to conduct said medium in the interior with low flow losses and in order at the same time to specify a rotor which is reliable and can be manufactured inexpensively, it is provided that a separately manufactured impeller wheel is arranged between the mutually adjacent hub regions of the two rotor disks, and that a sleeve is provided for fastening the impeller wheel to one of the two rotor disks, which sleeve extends through the central opening of the relevant rotor disk and, at its first end, comprises a collar which serves as a stop and a second end which lies opposite the first end, on which second end the impeller wheel is fastened.

Further advantages and features of the invention will be explained using a single exemplary embodiment.

### BRIEF DESCRIPTION OF THE DRAWINGS

In the drawing:

FIG. 1 shows a longitudinal section through a rotor of a turbomachine,

FIG. 2 shows a detail through the longitudinal section of a rotor according to the invention of a turbomachine with an impeller wheel which is arranged between two rotor disks, and

FIG. 3 shows an assembly comprising a second rotor disk, an impeller wheel and a sleeve in an exploded illustration.

### DETAILED DESCRIPTION OF INVENTION

Identical features are provided with the same designations in all figures.

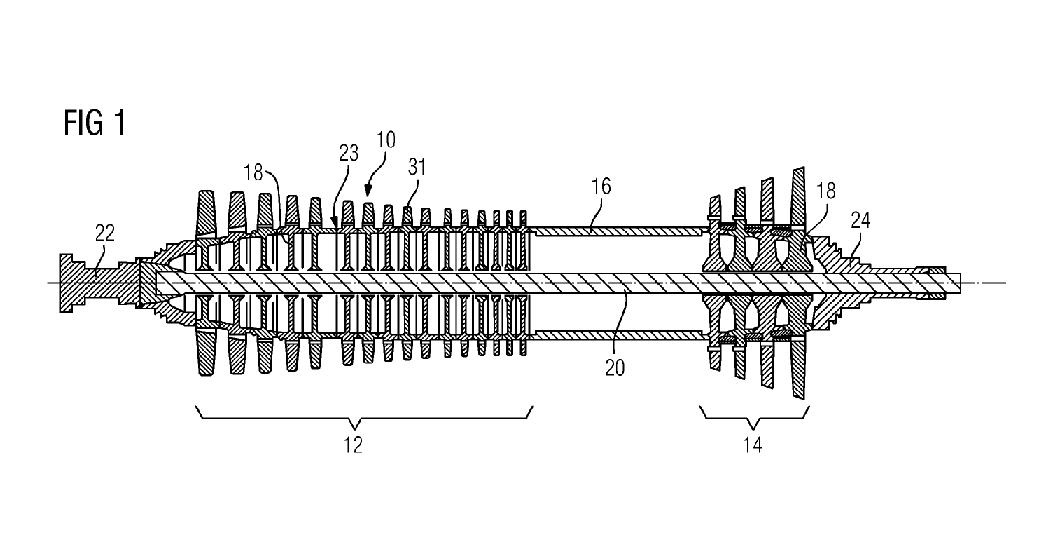

FIG. 1 shows the principal diagrammatic construction of a rotor 10 of a thermal turbomachine which, in the assembled state, is mounted such that it can be rotated about its rotational axis 13. In the exemplary embodiment which is shown, this is the rotor 10 of a stationary gas turbine. The rotor 10 might also be used in an aircraft gas turbine. On account of the use in a gas turbine, the rotor 10 comprises a compressor section 12 and a turbine section 14. A tube 16 is provided between the two sections 12, 14. Both the compressor section 12 and the turbine section 14 are of disk-type design. In the exemplary embodiment which is shown, the compressor section 12 comprises sixteen rotor disks 18 and the turbine section 14 comprises four rotor disks 18. A tie rod 20 extends through all rotor disks 18 and the tube 16, onto the two ends of which tie rod 20 what is known as a front hollow shaft 22 and what is known as a rear hollow shaft 24 are screwed. The two hollow shafts 22, 24 brace all the rotor disks 18 and the tube 16 with one another, with the result that relative movements in the circumferential direction are avoided as far as possible. In detail, this is by way of Hirth toothing systems which are arranged on the contact faces 23. They are not shown in further detail, however.

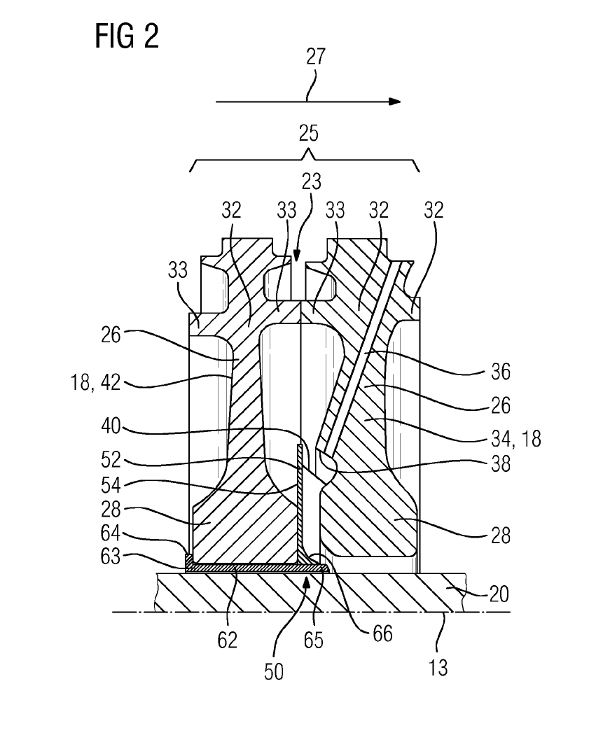

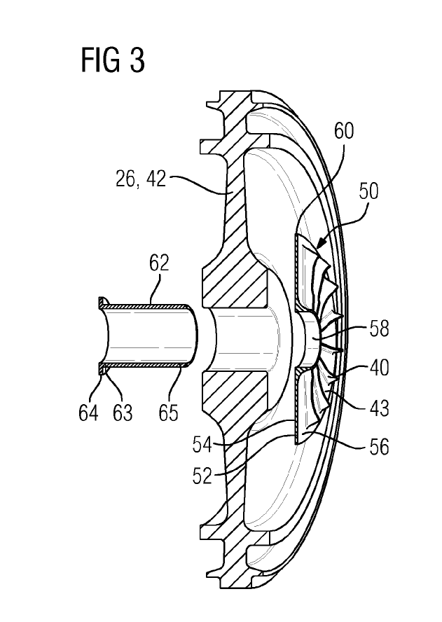

The features according to the invention are not shown in FIG. 1. Reference is made in this regard to FIGS. 2 and 3 which firstly show a detail of two arbitrary rotor disks 18 of the compressor section 12 from FIG. 1 which form a disk pair 25, however, on an enlarged scale, and secondly show an assembly of the rotor 10 in an exploded illustration.

In the operating state, air flows as a medium outside the rotor 10 in a main flow path (not shown in further detail) in the arrow direction 27, which air is compressed during this by the compressor.

Each rotor disk 18 has a disk web 26 which runs endlessly about the rotational axis 13. At its radially inner end, the disk web 26 has a hub region 28 with a central opening 30 which is concentric with respect to the rotational axis and, at its radially outer end, a rim region 32. The rim region serves to fasten rotor blades 31 (FIG. 1) and comprises collars 33 which are arranged on both sides and on which the adjacent rotor disks 18 bear against one another. The rotor disk 18 which is shown on the right-hand side in FIG. 2 is called the first rotor disk 34 in the following text, and the rotor disk which is shown on the left-hand side is called the second rotor disk 42. In addition, the first rotor disk 34 has holes which extend inward through the disk web 26 from the rim region and are distributed uniformly along the circumference of the disk web 26. Merely one of the holes is shown and is labeled with the designation 36. The holes 36 are inclined with respect to the radial direction in such a way that they penetrate the disk web 26 from one side to the other side. The holes 36 open with their radially inner end in a ring face 38 which is arranged obliquely with respect to the radial direction of the rotor disk 34.

An impeller wheel 50 is arranged between the two hub regions 28 of the immediately adjacent rotor disks 34, 42. The impeller wheel 50 comprises a plate-shaped rib carrier 52 with a first side 54 which is of planar configuration and with a second side 56 which lies opposite the first side 54. Ribs 40 are distributed uniformly along the circumference on the second side 56. Said ribs serve as guide elements for air which exits from the holes 36.

Each edge 43 of the ribs 40 which faces the hub region 28 of the first rotor disk 34 is contoured in such a way that its radial contour corresponds to the radial contour of the first rotor disk 34. Nevertheless, there is in each case a slight gap between the edges 43 and the hub region 28, in order to prevent wear. Just like the other rotor disk 18, the impeller wheel 50 also has a central opening 58, through which the tie rod 20 can extend.

A sleeve 62 is provided for secure fastening of the impeller wheel 50. Said sleeve 62 is seated in the central opening 30 of the second rotor disk 42 and has a collar at an axial first end 63, in order that the sleeve 62 can be supported laterally on the rotor disk 42. An external thread is provided at a second end 65 of the sleeve 62. The impeller wheel 50 is screwed onto said external thread, which impeller wheel 50 has an internal thread for this purpose in its central opening 58. The sleeve 62 is dimensioned in such a way that it can be inserted with an accurate fit or with low play in the central opening 30. Its internal diameter should be slightly greater in relation to the tie rod 20.

The ribs 40 are configured in such a way that they end radially on the outside immediately within the ring face 38. In order to ensure an inflow which is permissible and exhibits low flow losses of the air which exits from the holes 36 into the flow passages which exist between the ribs 40, the outer edge 60 of the rib carrier 52 lies on a greater radius than the outer ends of the ribs 40, in relation to the rotational axis 13.

The ribs 40 serve for flow guidance and to deswirl the air which flows from the holes 36 and is to flow into the interior of the rotor 10. That side of the first rotor disk 34, on which the ribs 40 are provided, is adjoined by a second rotor disk 42. On account of the use of the impeller wheel 50, the second rotor disk 42 can be of conventional configuration in the hub region 28.

As a result of the use of the impeller wheel 50, the flow passages can be delimited axially over the entire radial extent of the ribs 40, in which the cooling air which exits from the holes 36 enters and is conducted as far as the tie rod 20. This avoids swirling of the air at the inlet of each flow passage, which improves the efficiency of the air conducting. Aerodynamically favorable flow conducting near the tie rod 20 can be achieved by way of hollow channels 66 which the rib carrier has radially on the inside.

Since the central openings 30 of the rotor disks 18 are larger than the diameter of the tie rod 20, annular spaces are formed between the respective hub regions 28 and the tie rod 20, through which annular spaces the air which is conducted to the tie rod 20 can be conducted in the axial direction along the tie rod 20 from the compressor section 12 to the turbine section 14.

It goes without saying that the above-described disk pair 25 with the impeller wheel 50 which is connected in between can also be used to conduct the air which is conducted along the tie rod 20 toward the outside, as is necessary in the case of rotor disks 18 in the turbine section 14.

1. A rotor for a thermal turbomachine, comprising:
at least one pair of immediately adjacent rotor disks,
each rotor disk having a disk web which runs endlessly around its rotational axis and, at its radially inner end in relation to the rotational axis, has a hub region which is widened axially with respect to the disk web with a central opening which is concentric with respect to the rotational axis, and which has, at its radially outer end, an axially widened rim region for bearing against the adjacent rotor disk and for receiving rotor blades,
wherein the first of the two rotor disks having a multiplicity of bores which are distributed along the circumference, extend inward from the rim region, penetrate the disk web, and open in a ring face of the rotor disk, which ring face is arranged obliquely with respect to the radial direction, and
an impeller wheel is arranged between the mutually adjacent hub regions of the two rotor disks, the first side of which impeller wheel bears against the hub region of the second rotor disk and the second side of which impeller wheel which lies opposite the first side has a number of ribs which extend inward from the outside, and
a sleeve adapted for fastening the impeller wheel to one of the two rotor disks, which sleeve extends through the central opening of the relevant rotor disk and, at its first end, comprises a collar which serves as a stop and a second end which lies opposite the first end, on which second end the impeller wheel is fastened.

2. The rotor as claimed in claim 1,
wherein the impeller wheel comprises a plate-shaped rib carrier, the outer edge of which lies on a larger radius than the outer ends of the ribs.

3. The rotor as claimed in claim 1,
wherein, in order to fasten the impeller wheel to the sleeve, the sleeve has an external thread at its second end, onto which external thread the impeller wheel is screwed such that it braces the second rotor disk.

4. The rotor as claimed in claim 1,
wherein the impeller wheel is of hollow channel-like configuration on the second side radially on the inside between the ribs in order to deflect a flow.
